(19) United States
(12) Patent Application Publication
(10) Pub. No.: US 2016/0075961 A1
(43) Pub. Date: Mar. 17, 2016

(54) CHARCOAL CHIMNEY

(71) Applicant: HOTTROX, INC., Tiburon, CA (US)

(72) Inventors: Lindsay Leveen, Tiburon, CA (US); Sudhir Joshi, Emerald Hills, CA (US); Peter Winder, Corte Madera, CA (US); David C. Morris, New York, NY (US)

(73) Assignee: HOTTROX, INC., Tiburon, CA (US)

(21) Appl. No.: 14/855,858

(22) Filed: Sep. 16, 2015

Related U.S. Application Data
(60) Provisional application No. 62/050,876, filed on Sep. 16, 2014.

(51) Int. Cl. C10L 11/04; A47J 37/07; C10L 5/04; C10L 5/40; C10L 5/08

(52) U.S. Cl. CPC C10L 11/04; C10L 5/403; C10L 5/08; C10L 5/04; A47J 37/079; C10L 2230/06; C10L 2290/20; C10L 2290/08

(57) ABSTRACT

Embodiments described herein are generally directed to a charcoal chimney that may hold charcoal. The charcoal chimney may be formed of a material that is combustible. The charcoal chimney is generally intended as a single use chimney. The charcoal chimney may be associated with a non-toxic fire-retardant or ignition delay substance that delays combustion of the chimney for at least an initial heating phase. The ignition delay substance may be a coating on one or more surfaces of the charcoal chimney. The ignition delay substance may be impregnated or otherwise formed into the material forming the charcoal chimney. The ignition delay substance may be both coated onto and impregnated into the charcoal chimney. The fire-retardant or ignition delay substance is generally intended to delay the combustion of the charcoal chimney for a period of time. The chimney may be provided with suitable air holes to facilitate airflow around the charcoal and within the chimney.

### CROSS REFERENCE TO RELATED APPLICATIONS

This application is related to and claims priority benefit from U.S. Provisional Application No. 62/050,876, filed on Sep. 16, 2014, entitled BARBECUE TOWER, the entire contents of which are incorporated herein by reference.

### FIELD OF THE INVENTION

Embodiments described herein generally relate to one-time use charcoal chimneys or chimney starters for charcoal grills or the like.

### BACKGROUND

Many people cook food on outdoor grills or barbecues, which typically have a heat source that uses charcoal (lump charcoal or charcoal briquettes), gas (propane or natural gas), or electric coils. Many people prefer the taste of food cooked over charcoal; however, gas grills are popular because they are quick, clean and convenient. Lighting a conventional charcoal grill and raising the temperature to cooking temperatures is often dirty, slow, and inconvenient. One approach is to use a petroleum-based lighter fluid to reduce the preparation process; however, in some instances, lighter fluid imparts an unsavory petroleum taste to the grilled food. The “instant-light” charcoal briquettes (which typically contain lighter fluid) often have the same issue of petroleum artificial taste. Furthermore, after a container of instant-light charcoal is open, the lighter fluid often evaporates over time such that the charcoal functions as typical charcoal (without lighter fluid) for subsequent uses of charcoal from the container.

Using a metal chimney eliminates the need for lighter fluid but requires a user to load the chimney with charcoal, insert newspaper, paraffin, or other flammable material, and ignite the materials. Once the charcoal has reached the desired temperature, the user must handle a hot metal canister (often hotter than 500° F.) and pour red hot charcoal from the metal chimney into a grill. Due to the high temperatures involved, these processes can be challenging and unsafe (including a risk of flying embers).

There is thus a need for a charcoal grilling apparatus and method that allows use of charcoal in a of charcoal in a charcoal chimney in a safe, quick, clean, and convenient way.

### BRIEF SUMMARY

Embodiments described herein are generally directed to a charcoal chimney that may hold charcoal. The charcoal chimney may be formed of a material that is combustible. The charcoal chimney is generally intended as a single use chimney. The charcoal chimney may be associated with a non-toxic fire-retardant or ignition delay substance that delays combustion of the chimney for at least an initial heating phase. The ignition delay substance may be a coating on one or more surfaces of the charcoal chimney. The ignition delay substance may be impregnated or otherwise formed into the material forming the charcoal chimney. The ignition delay substance may be both coated onto and impregnated into the charcoal chimney. The fire-retardant or ignition delay substance is generally intended to delay the combustion of the charcoal chimney for a period of time. The chimney may be provided with suitable air holes to facilitate airflow around the charcoal and within the chimney.

In one example, there is provided a charcoal chimney comprising: a chimney body comprising an interior cavity, at least one surface of the chimney body comprising a combustible material; at least one hole in the chimney body; and a non-toxic ignition delay substance associated with the at least one surface of the chimney body comprising a combustible material, wherein the non-toxic ignition delay substance delays ignition of the charcoal chimney upon application of heat during a first heating phase. The first heating phase may be up to about 30 minutes, and subsequent continued heating can cause the charcoal chimney to combust. The non-toxic ignition delay substance may be one or more of lime, casein protein, lime plaster, mud, plaster, mortar, cement, Portland cement, gypsum, gypsum plaster, plaster of Paris, or a combination thereof. The combustible material may be one or more of paper, cardboard, papier-mâché, paper pulp, paper board, molded pulp, or any combination thereof.

The non-toxic ignition delay may be an at least partial coating on at least one surface of the chimney body. The at least partial coating may be a coating on all surfaces of the chimney body, at least two coatings on one or more surfaces of the chimney body, or combinations thereof. The non-toxic ignition delay substance may be formed into the combustible material such that it impregnates the chimney body. Both options are also possible and considered within the scope of this disclosure.

Examples also provide a method of using a charcoal chimney, the method comprising: providing a charcoal chimney comprising a combustible material and a non-toxic ignition delay substance that delays ignition of the charcoal chimney upon application of heat during a first heating phase, wherein the charcoal chimney is configured to contain charcoal; applying heat to charcoal disposed within the charcoal chimney, wherein the charcoal burns for the first heating phase without combusting the charcoal chimney, and wherein after the first heating phase, the charcoal chimney ignites from heat of the charcoal. The charcoal chimney may be provided pre-loaded with charcoal.

Examples also provide a method of manufacturing a charcoal chimney, the method comprising: forming a chimney body comprising an interior cavity out of a combustible material; applying one or more coats of a non-toxic ignition delay substance to at least one surface of the chimney body, wherein the non-toxic ignition delay substance delays ignition of the charcoal chimney upon application of heat during a first heating phase; and allowing the non-toxic ignition delay substance to dry or cure. The method of manufacturing may also include pre-loading charcoal in the charcoal chimney; and packaging the chimney body.

### BRIEF DESCRIPTION OF THE DRAWINGS

FIG. 1 is a perspective view of a charcoal chimney according to certain embodiments of the present invention.

FIG. 2 is a perspective view of the charcoal chimney of FIG. 1, having a top.

FIG. 3 is a perspective view of the charcoal chimney of FIG. 1 with the top removed.

FIG. 4 is a perspective view illustrating charcoal contained in a charcoal chimney.

FIG. 5 is a perspective view of a bottom of the charcoal chimney of FIG. 1.

FIG. 6 is a top view of the charcoal chimney of FIG. 1 with the top removed.

FIG. 7 is a perspective view of molded charcoal briquettes according to certain embodiments of the present invention.

FIGS. 8A and 8B are perspective views of molded charcoal briquettes according to certain embodiments of the present invention.

FIGS. 9A and 9B are top views of the molded charcoal briquettes of FIGS. 8A and 8B.

FIGS. 10A, 10B, and 10C are perspective views of charcoal briquette arrangement devices according to certain embodiments of the present invention.

FIG. 11 is a perspective view of a charcoal chimney according to certain embodiments of the present invention.

FIG. 12 is a top view of the charcoal chimney of FIG. 11.

FIG. 13 is a side view of the charcoal chimney of FIG. 11.

FIG. 14 is a bottom view of the charcoal chimney of FIG. 11.

FIGS. 15A is a bottom view of a charcoal chimney containing a combustible material in a central hole.

FIG. 15B is a bottom view of a charcoal chimney having a fuse.

### DETAILED DESCRIPTION

Embodiments described herein are generally directed to a charcoal chimney that may hold charcoal briquettes. The charcoal chimney may be formed of a material that is combustible. However, the charcoal chimney may also be associated with a fire-retardant or ignition delay substance. The ignition delay substance may be a coating on one or more surfaces of the charcoal chimney. The ignition delay substance may be impregnated or otherwise formed into the material forming the charcoal chimney. The ignition delay substance may be both coated onto and impregnated into the charcoal chimney. The fire-retardant or ignition delay substance is generally intended to delay the combustion of the charcoal chimney for a period of time. The chimney may be provided with suitable air holes to facilitate airflow around the charcoal and within the chimney.

The charcoal chimney may either be provided pre-filled with charcoal or a user may add a particular type of charcoal desired into the charcoal chimney. If pre-filled, the charcoal briquettes may be provided in the form of a self-supporting stack. For example, there may be an interior structure designed to hold and/or space pre-loaded charcoal elements. The charcoal elements may be several individual briquettes or they may be molded together. In another example, if provided as a pre-filled chimney, the charcoal may be randomly packed or provided in the interior of the chimney.

In use, a charcoal chimney that is at least partially filled with charcoal briquettes may be positioned inside a grill. A user may light a wick, a portion of the charcoal chimney, or some other combustible material in close proximity to the charcoal chimney. The charcoal chimney generally concentrates heat in order to encourage burning of the charcoal contained therein during a first heating phase. The charcoal chimney itself does not immediately combust due to the ignition delay substance. However, at some point during the charcoal heating process, the charcoal chimney will begin to burn during a second heating phase. This allows the chimney to function as a chimney during the first heating phase, and to function as additional heat and flame during its combustion in the second heating phase. Structure of Charcoal Chimney

The charcoal chimney is generally formed with an interior that can contain and support enough charcoal for the desired size grill or drum barbeque. It may also be formed with sufficient holes for proper air flow. It should be understood that the charcoal chimney can be any shape or size. The primary feature is that it is coated with, impregnated with, or otherwise associated with an ignition delay substance. The following examples are for illustrative purposes only and are not intended to be limiting in any way. The charcoal chimney is designed to be a single-use chimney made of a combustible material. It holds charcoal in use, but itself begins to smolder after an initial heating phase.

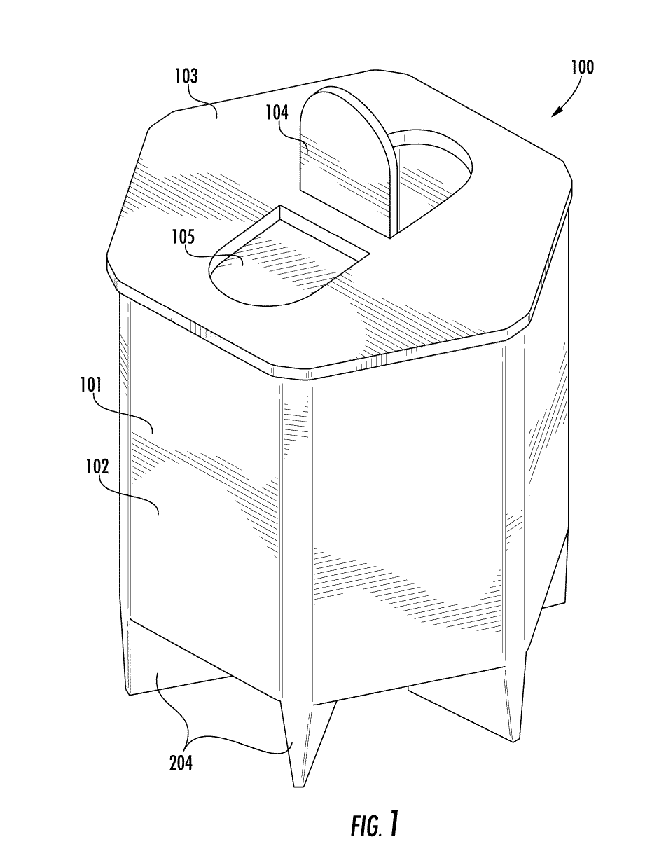

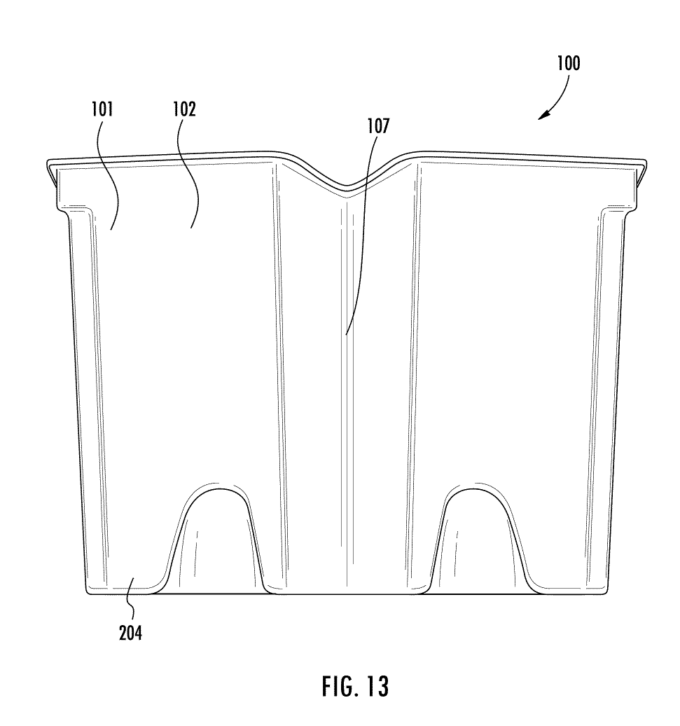

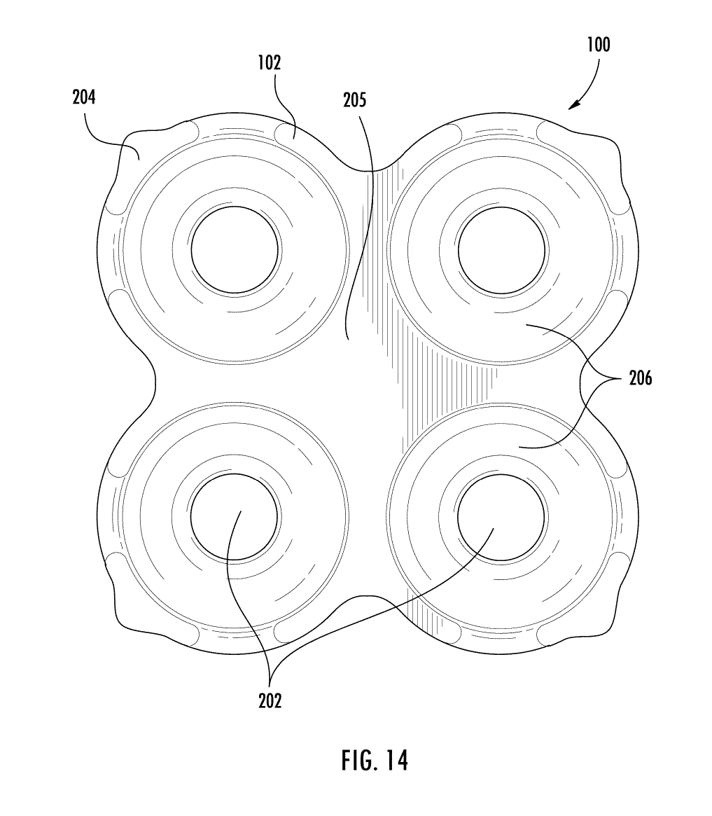

FIGS. 1-15B illustrate embodiments of charcoal chimneys 100. For example, as shown in FIG. 1, the charcoal chimney 100 may be formed as chimney body 102. The charcoal body 102 may be formed into any appropriate shape, such as a cylinder, box, prism, extruded hexagon, truncated cone, frustum, extruded triangle, extruded pentagon, or any other shape. The general intent is to provide a container with an interior cavity 106. In the examples shown, the chimney body is 102 may be formed as a rigid container configured to contain charcoal briquettes or lump charcoal. The chimney body 102 may include a one or more side walls 101 and one or more base walls 201 that collectively form a cavity 106, generally providing an enclosure structure.

The cavity 106 may be generally configured to hold an appropriate amount of charcoal for a consumer barbecue or grill. For example, the cavity 106 may be approximately 1-24 inches tall, 1-24 inches wide, and 1-24 inches deep. In some embodiments, the cavity is approximately 5-9 inches tall, 5-9 inches wide, and 5-9 inches deep. The cavity may have a volume of approximately 0.1-8 qt. In one example, the charcoal chimney may be tall enough to hold three or more layers of charcoal. For example, the cavity 106 may be configured to hold an appropriate amount of charcoal for a 14″, 18″, or 22″ kettle grill. In other embodiments, the cavity 106 may be configured to hold an appropriate amount of charcoal for a 30″ barrel grill. It should be understood that the chimney body 102 may be provided in any desired shape or size, depending on the intended size and use. It is also desired at the charcoal chimney have a sufficiently wide base that allows it to sit on a grate without toppling over. It is also desirable that the charcoal chimney be elevated above the grate in order to allow airflow beneath the chimney.

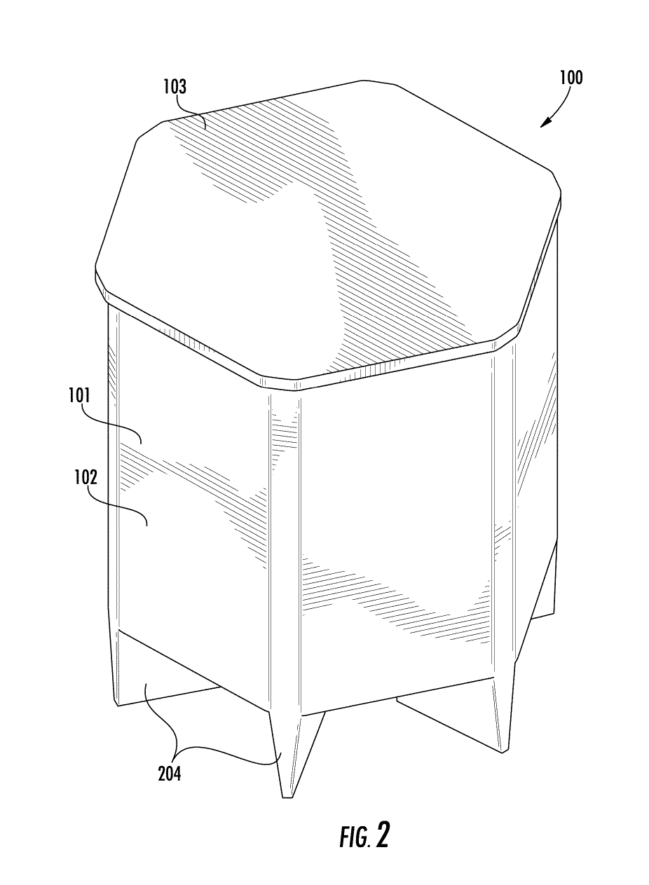

As shown in FIGS. 1 and 2, the charcoal chimney 100 may include a top 103 that attaches at or near the upper edges of the side walls 101. The top 103 may be removable. As illustrated by FIG. 1, the top 103 may include one or more openable openings 105. In one example, openings 105 may include a flap 104. The opening(s) 105 may be opened or closed to adjust airflow through the chimney 100. The openings 105 may be provided as having a variable adjustment option. As illustrated by FIG. 2, the top 103 may be configured without any holes.

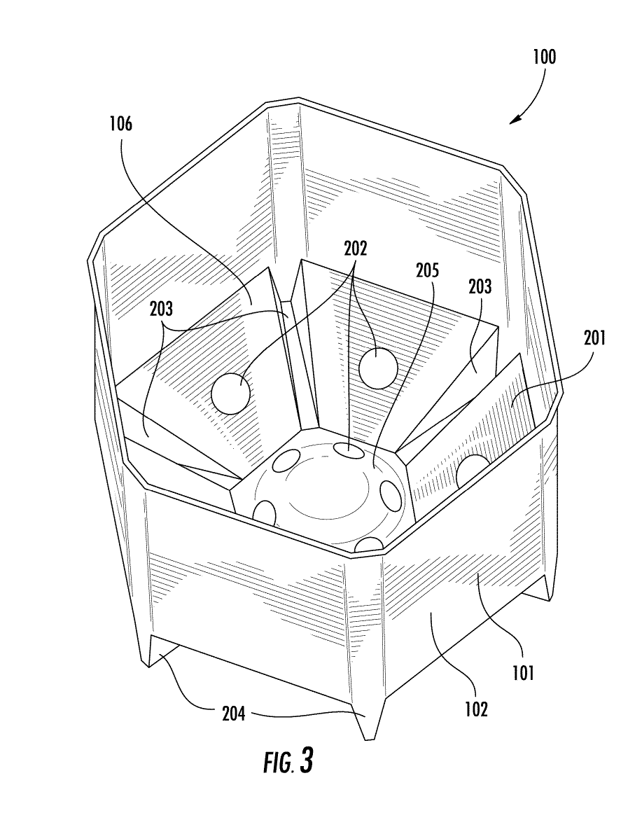

As shown in FIG. 3, there may be provided one or more holes 202 in the chimney body 102 to encourage airflow and circulation through the charcoal chimney body 102. For example holes 202 may be provided in one or more sidewalls 101, in the one or more base walls 201, or both. Although the one or more holes 202 are primarily illustrated at the bottom of the chimney 100, it should be understood that the holes 202 may be located on any part of the chimney 100, including the side wall 101. Holes 202 may encourage air flow and circulation through the chimney body 102 in order to improve combustion. In use, air is allowed to flow into the hole(s) 202, through the chimney body 102, and out the one or more opening 105 in the top 103.

The base of the chimney 100 may include one or more feet 204 that extend below a bottom surface of the chimney 100. The feet 202 may also help encourage airflow. In use, they may elevate the chimney body 102 off of the barbecue grate or grill floor. In a specific example, the feet may elevate the chimney body a few centimeters up to a few inches.

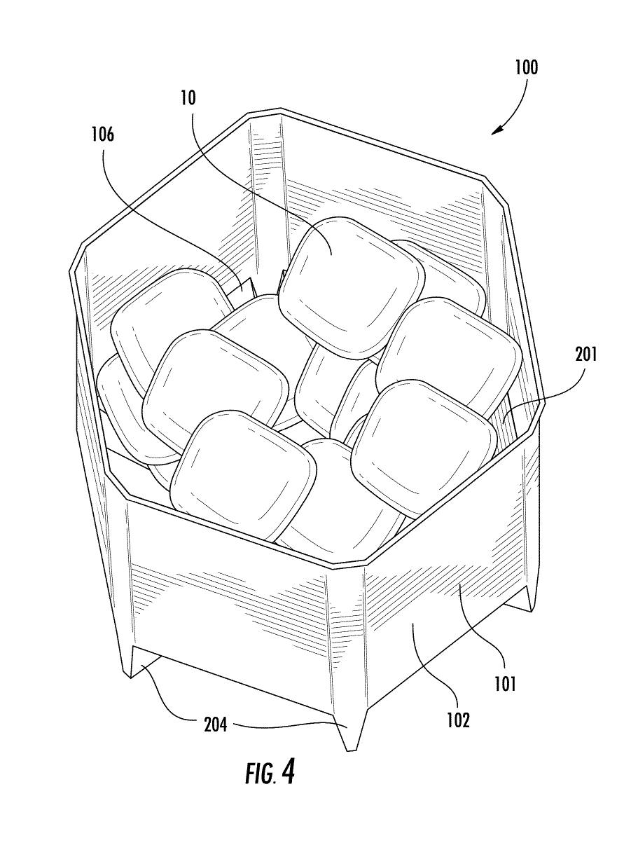

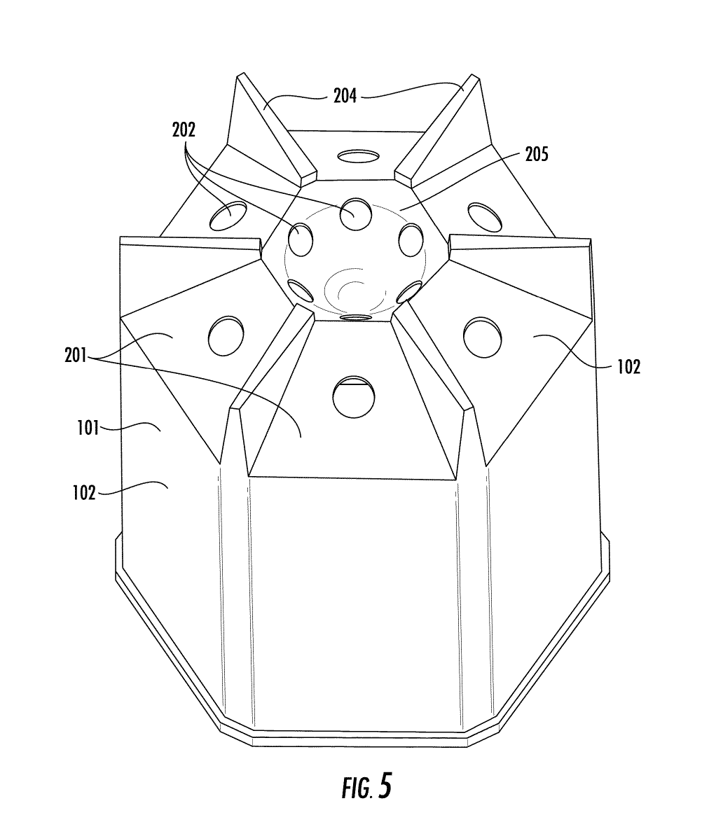

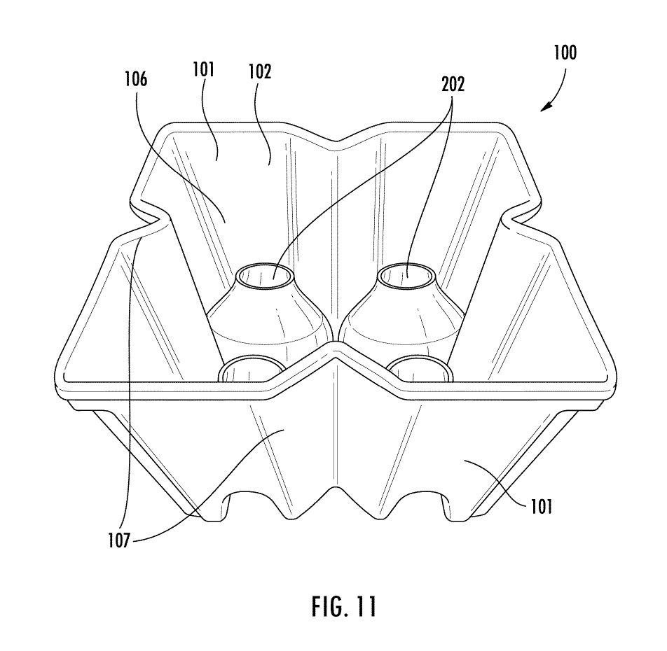

As shown in FIGS. 3-6, the interior of the chimney body 102 defines a cavity 106. The base of the chimney body 102 may include one or more panels that form base walls 201. As shown in FIG. 4, the base of the charcoal chimney 100 is generally configured to have a strength sufficient to support multiple layers of charcoal 10. FIGS. 3 and 5 illustrate an embodiment in which the base walls 201 are inwardly angled with respect to the sidewalls 101. They may be oblique or otherwise angled with respect to the side walls 101. In other examples, the base walls 201 may be approximately perpendicular to the side walls, as shown in FIGS. 11-15B (which are described in more detail below). Although not shown, it is possible for the base of the chimney body 102 to be formed as a single flat panel.

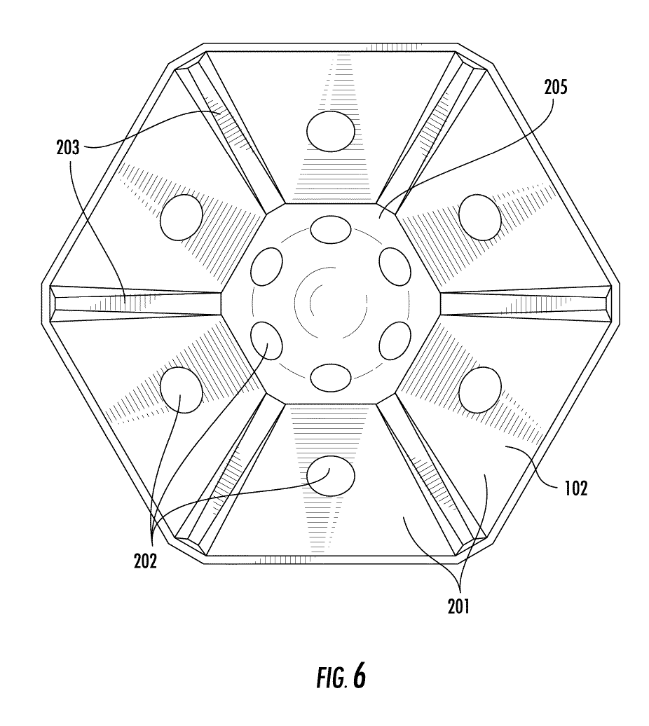

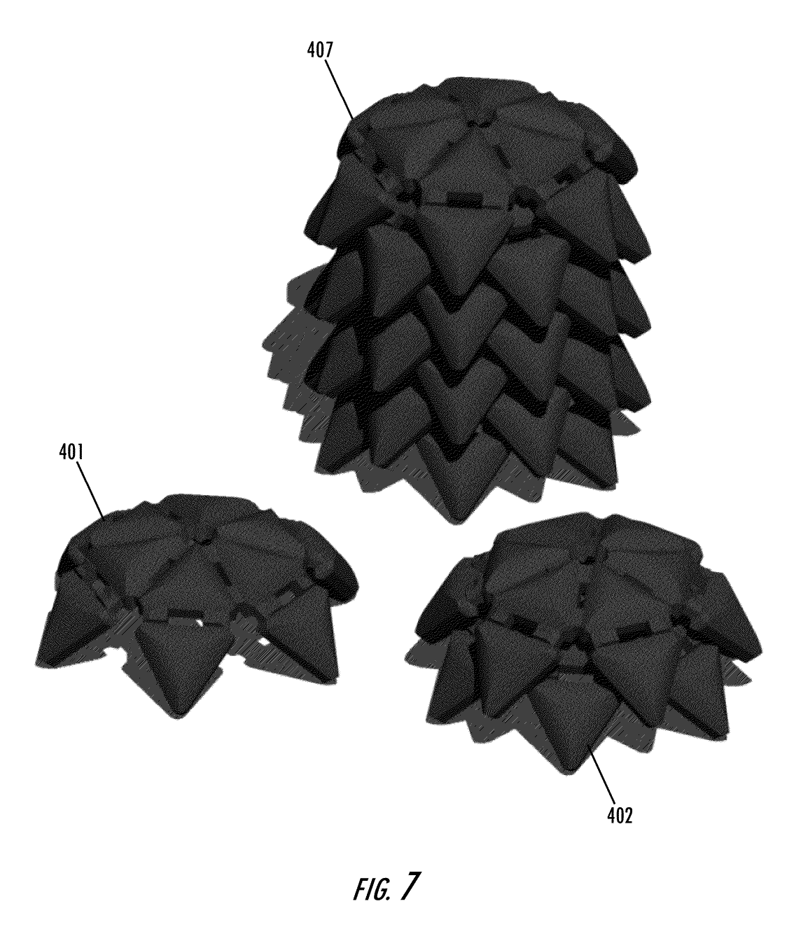

The chimney body 102 may include one or more base walls 201 located radially around a central hole 202. FIG. 6 illustrates a multi-sided chimney having six sidewalls 101 and six base walls 201. FIG. 7 illustrates a four-sided chimney having base walls 201 located radially around the hole 202. It should be understood, however, that the chimney 100 may include any number of sides and/or any number of base walls 201. In any of these examples, it has been found useful to provide a central hole 202 or one or more holes (FIGS. 5-6) in the bottom of the chimney. The central hole 202 may include portions that overlap multiple base walls 201 such that each panel 201 comprises a hole 202 or a portion of hole 202.

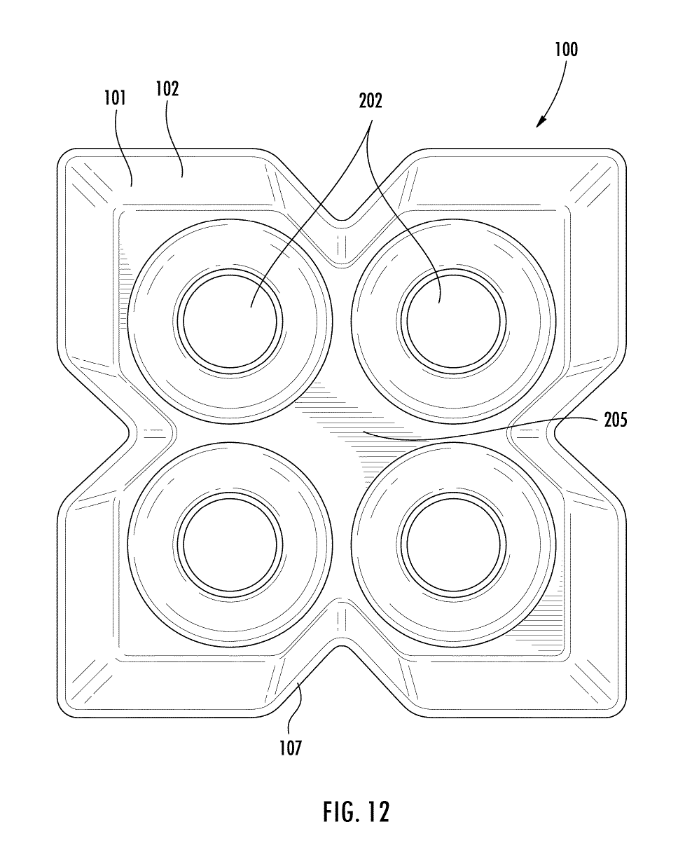

In some embodiments, the base walls 201 may include a center panel 205. The center panel 205 may have a partial spherical shape, shown in FIG. 3. The center panel 205 may be a raised panel with respect to the other panels. In another example, the center panel 205 may be a flat area, shown in FIG. 12. Alternatively, the base of the chimney need not include a center panel. In some embodiments, it is possible for the center of the bottom of the chimney to include a hole 202.

The base walls 201 may have holes 202. Additionally or alternatively, the center panel 205 may have holes 202. This hole 202 may help encourage airflow and heat up into and through the chimney 100.

Referring back to FIGS. 3 and 5-6, the base walls 201 may include one or more recesses 203, which may be formed as depressions or slots or any other indented area. In some embodiments, the recesses 203 may correspond to the location of the feet 204. To the extent that each foot 204 extends below the lower surface of the chimney 100, there can be a corresponding recess 203 in the cavity 106. For example, the recesses 203 may be designed to be smaller than the smallest dimension of a typical charcoal briquette. This can prevent a charcoal briquette from blocking the desired air flow area.

The arrangement of the base walls 201, central panel 205, and/or the recesses 203 can help ensure that there is sufficient room for air to circulate under and around the charcoal. This can also help ensure efficient combustion during the initial combustion stage.

In some embodiments, the chimney body 102 shape may be provided as general box-like shape, having sidewalls 101, base walls 201, and a central hole 202. It may be provided with feet 204, as well as interior recesses 203, as described above. There may be provided a flange positioned around an upper edge of the chimney body 102. The flange may be an integral component of the chimney body 102. In another example, the flange may be a separate component that is secured to or otherwise applied to the chimney body 102. The flange may provide structural stiffness to the side walls 101 (particularly to the upper perimeter of the side walls 101).

FIGS. 11-14 illustrate an alternate embodiment of a chimney body 102 shape. As shown, the bottom of the chimney 100 may include surfaces projecting upward toward the interior of the chimney 100. For example, these surfaces may be shaped as a trumpet like protrusions with a hole 202. They may be conically shaped. They may be circular. They may be triangular/pyramidal. It should be understood that the projecting surfaces may be any other appropriate shape that can protrude into the cavity 106 portion. In some embodiments, the charcoal chimney 100 may also include a notch 107 extending along one or more side walls 101. The notch 107 may function to provide spread out pieces of charcoal within cavity 106. This can help ensure sufficient airflow to optimize combustion. The notch 107 may function to provide structural stiffness to the side walls 101.

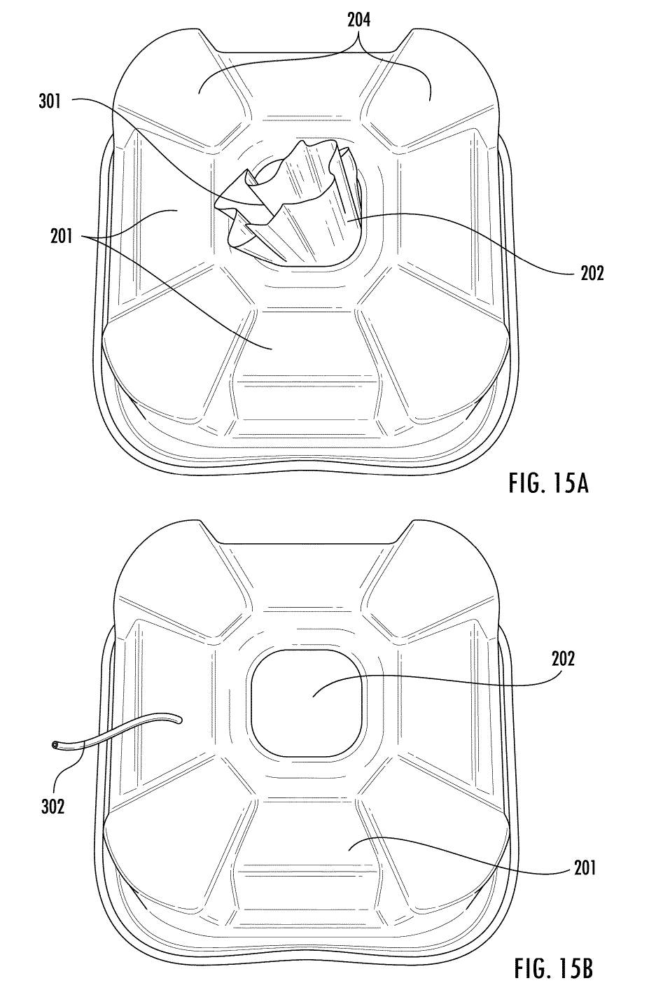

In some embodiments, the charcoal chimney 100 may include an easily ignitable portion configured to start the combustion process, such as a wick or a fuse. For example, as shown in FIG. 15A, the chimney 100 may include paper 301 that acts as a wick or fuse. In one example, the paper 301 may be inserted through hole 202. The paper 301 may be newspaper, paper pulp, cardboard, or any other type of paper product that is easily ignitable. The chimney 100 may be provided with a pre-inserted ignitable element. In other embodiments, the paper 301 may be layered underneath the charcoal 10 in the chimney 100 during use.

As shown in FIG. 15B, in addition to or in lieu of the paper 301, the chimney 100 may include a fuse 302 that protrudes through a hole 202. In another example, the fuse 302 may protrude directly through a base wall 201. Although not shown, the fuse 302 may alternatively or additionally protrude through a side wall 101. The fuse 302 may include a string, bundles of string, hemp, cotton rope, or any other combustible material that can encourage burning. The fuse 302 may be soaked, coated, or saturated in vegetable oil, paraffin oil, paraffin wax, or some other easily ignitable material. The fuse 302 may take the form of a candle wick. In any of these examples, the general intent of the fuse 302 is to direct a flame to the chimney body 102.

### Materials/Ignition Delay

The charcoal chimney 100 may be constructed from a combustible material. For example, the chimney body 102 may have one or more surfaces made of paper, cardboard, papier-mâché, paper pulp, paper board, molded pulp, any other suitable combustible material, or combinations thereof. (It should be understood that it is also possible to provide certain components of the charcoal chimney 100 that are not of a combustible material. For example, it may be found that providing a metal base structure may help provide additional support.

However, embodiments in which the entire charcoal chimney 100 is made of a combustible material may provide the cleanest user experience.)

In one example, the general goal is to coat the chimney 100 in a way that creates some predictability about the rate of burn that will keep the chimney intact for sufficient time to light the charcoal, but then allow the chimney to burn away, adding additional heat to the process and igniting the charcoal. It is desirable for the chimney to resist combustion for a long enough time to allow it to act like a chimney—to concentrate heat of combustion and to provide adequate air for combustion to ignite a sufficient number of briquettes or lumps of charcoal. This time may be referred to as a first heating phase. In some examples, the first heating phase may be about 5-20 minutes. In some examples, the first heating phase may be up to about 30 minutes. In a specific example, the first heating phase may be about 8-10 minutes. After the time of the first heating phase passes, the charcoal chimney 100 will ignite. This provides additional heat for lighting briquettes or lumps of charcoal, and the chimney will turn into ash. The ash from paper pulp chimney and coating can become part of the ash from briquettes or lumps of charcoal.

In order to prevent the charcoal chimney 100 from immediately igniting upon application of a flame, an ignition delay substance may be provided associated with at least one or all of the surfaces of the chimney body 102. For example, the substance may provide as an at least partial coating on one or more surfaces. In other examples, the ignition delay substance may be formed or otherwise mixed in with the material forming the structure of the charcoal chimney 100. If provided as a coating, the ignition delay substance may be provided on outer surfaces, on inner surfaces, on upper surfaces, and/or on lower surfaces of the charcoal chimney. The ignition delay substance may be a full coating on a surface, an at least partial coating on a surface, at least two layers or coatings on a surface, impregnated into one or more surfaces, or combinations thereof

The ignition delay substance associated with some or all of the surfaces of the chimney 100 generally acts as a fire retardant or flame retardant by delaying ignition and immediate combustion of the charcoal chimney 100. The ignition delay substance may be coated on to the chimney body 102 by coating, painting (rolling or brushing), spraying, dipping, doctor blading, spackling, combinations thereof, or any other appropriate application technique. The coating is generally intended to be an ignition delay substance that will delay combustion of the charcoal chimney for a period of time, the “first heating phase.” Any ignition delay substance that may be applied or incorporated into a combustible material may be used and is considered within the scope of this disclosure.

For example, the ignition delay substance may be non-toxic, inert, natural, a good insulator of heat, may adhere to the paper pulp chimney well (for ease of manufacture, transport and used in barbecue application). It is generally desirable that the non-toxic ignition delay substance not give off a toxic fume such as formaldehyde or other toxins, because the ignition delays substance is in such close contact with food intended for human consumption.

In some examples, the material can be suspended in water and applied as slurry to a paper pulp chimney, in order to coat it evenly. The ignition delay substance may be lime (or lime plaster), mud, plaster, mortar, cement, Portland cement, gypsum, gypsum plaster, plaster of Paris, or mixtures thereof. Water-based slurries of lime, cement, Portland cement, gypsum, plaster of Paris or mixtures thereof, can be used to coat the chimney body 102.

Another potential non-toxic ignition delay substances may include milk proteins called caseins, a byproduct of cheese production. Caseins, like conventional flame retardants, are high in phosphorus, but they are non-toxic and natural and do not release dangerous gases such as formaldehyde like conventional flame retardants do. Various combinations of caseins/milk proteins may be coated or impregnated into the charcoal chimneys or both. The caseins may form a char layer of incombustible carbon on the chimney and can potentially retard flames at a desired rate.

Any of these materials or combinations thereof may be mixed in various ratios and applied to one or more surfaces of the charcoal chimney. In other examples, any of these materials or combinations thereof may be mixed in various ratios and incorporated into the base material that forms the structure of the charcoal chimney body 102. For example, flame retardant materials may be impregnated into the chimney body 102.

If applied as a coating, the coating should generally be thick enough to impart the desired fire-resistance for a first heating phase, but not so thick that it will flake off during transportation and handling. Additionally, the coating thickness may be controllable. Depending on consumer and product needs, the coating may be provided as having a proper thickness that provides adequate heat resistance to make the coated chimney fire retardant for a specified time and then burn away, providing heat for igniting charcoal. Different types of charcoal require different lengths of time and/or different amounts of heat to ignite properly. The coating process can be designed to be flexible enough to allow for such controlled variation in coating thickness or choice of coating materials.

The thickness (viscosity) of the coating slurry and its composition may determine how well it will adhere to the combustible material of the chimney body 102. It should be understood that the examples provided below are for illustration purposes only, and the ratios and amounts of materials used may be varied depending upon the application method to be used and the viscosity or thickness of the desired coating.

### EXAMPLES

### Example 1—Coating with Portland Cement

Five lb. of Portland cement was mixed vigorously with four lb. of water mixture that comprises approximately 1.25:1 ratio of Portland cement to water. The mixture may comprise approximately 1.25:1 ratio of Portland cement to water. The resulting slurry was kept in suspension by stirring intermittently. Paper pulp containers were painted on all sides using a thick brush used for painting indoor walls. The coating was thick enough to hide the paper pulp surface and smooth over the bumps in the paper pulp surface. The resulting coated containers were dried in the sun for at least 4 hours. The coated containers were stored indoors for several days before testing in a barbecue.

### Example 2—Coating with Lime

Five lb. of lime was mixed vigorously with 3.5 lb. of water. The resulting slurry was kept in suspension by stirring intermittently. Paper pulp containers were dipped in the slurry to coat all sides thoroughly. The resulting coated containers were dried in the sun for at least 4 hours. The coated containers were stored indoors for several days before testing in a barbecue.

### Example 3—Coating with a Mixture of Portland Cement and Plaster of Paris

The following various ratios were tested:
5 lb. of plaster of Paris with 0.5 lb. of Portland cement mixed vigorously with 3.5 lb. of water;
5 lb. of plaster of Paris with 50 gms. of Portland cement mixed vigorously with 3.2 lb. of water;
5 lb. of plaster of Paris with 100 gms. of Portland cement mixed vigorously with 3.7 lb. of water; and
5 lb. of Portland cement with 500 gms. of Portland cement mixed vigorously with 4.2 lb. of water.
   In some embodiments, gypsum may be substituted or partially substituted for plaster of Paris. The mixture may comprise a ratio of between approximately 20:1 to 70:1 of plaster of Paris (and/or gypsum) to Portland cement and a ratio of between approximately 1:1 to 3:1 of plaster of Paris (and/or gypsum) to water. In another example, the mixture may comprises approximately 50:1 ratio of plaster of Paris (and/or gypsum) to Portland cement and approximately 1.5:1 ratio of plaster of Paris (and/or gypsum) to water. In all examples, the resulting slurry was kept in suspension by stirring intermittently. Paper pulp containers were dipped in the slurry to coat all sides thoroughly. The resulting coated containers were dried in the sun for at least 4 hours. The coated containers were stored indoors for several days before testing on a grill.

### Example 4—Coating with Plaster of Paris

The ignition delay substance may be a mixture of plaster of Paris, Portland cement, and water. In some embodiments, gypsum may be substituted or partially substituted for plaster of Paris. In a first example, five lb. of plaster of Paris (and/or gypsum) was mixed vigorously with 4 lb. of water. The mixture may have a ratio of approximately 1:1 to 5:1 of plaster of Paris (and/or gypsum) to water. In a second example, five lb. of plaster of Paris (and/or gypsum) was mixed vigorously with 2.5 lb. of water. The ratio may be approximately 1.25:1 ratio of plaster of Paris (and/or gypsum) to water. In other embodiments, the ratio may be approximately 2:1 to 10:1 of plaster of Paris (and/or gypsum) to water. In all examples, the resulting slurry was kept in suspension by stirring intermittently. Paper pulp containers were dipped in the slurry to coat all sides thoroughly. The resulting coated containers were dried in the sun for at least 4 hours. The coated containers were stored indoors for several days before testing in a barbecue.

### Example 5—Coating with Lime Plaster

In a first example, five lb. of lime plaster was mixed vigorously with 2.5 lb. of water. The ratio may be approximately 1:1 to 5:1 of lime to water. In a second example, 5 lb. of lime plaster was mixed vigorously with 4 lb. of water. The ratio may be approximately 1.43:1 ratio of lime to water. In both examples, the resulting slurry was kept in suspension by stirring intermittently. Paper pulp containers were dipped in the slurry to coat all sides thoroughly. The resulting coated containers were dried in the sun for at least 4 hours. The coated containers were stored indoors for several days before testing in a barbecue.

### Example 6—Coating with Mud

In one example, a portion of mud and/or a combination of mud and sand may be mixed with water to create a paste-like substance. The ratio may be approximately 1:1 to 5:1 of mud to water. The resulting slurry was kept in suspension by stirring intermittently. Paper pulp containers were dipped in the slurry to coat all sides thoroughly.

In some embodiments, the ignition delay substance may be applied to the surface(s) of the charcoal chimney 100 and allowed to cure. To cure the ignition delay substance, the chimney 100 may be dried at room temperature, may be cured under sunlight, may be dried in an oven, and/or may be cured under a ultraviolet lamp, and/or may be cured in a microwave oven. The curing process may, in certain embodiments, may extend for approximately four hours. This time may be more or less, depending upon the curing process used.

To increase the predetermined time, after a first layer of the ignition delay substance is either partially or fully cured, a second layer of the ignition delay substance may applied on top of the first layer of ignition delay substance.

In another embodiment, the materials of the ignition delay substance may be mixed with the materials of the chimney 100 before or during the manufacturing process of the chimney 100. For example, for molded pulp or paper products, the material of ignition delay substance may be mixed with the raw or non-cured material (e.g., fibrous slurry, paper pulp, etc.) used to make the charcoal chimney 100 before the material is cured or molded. (For example, by vacuum molding and/or by heating the mold or in an oven). Based on the material and composition of the coating, the ignition delay substance is desirably applied thick enough to delay ignition (and subsequent combustion) of the chimney based on a desired temporal and/or temperature criteria. The thicknesses may be varied depending upon the size of the charcoal chimney, the amount of charcoal to be contained, and other desired parameters. Any of the above-discussed materials may be incorporated into the chimney body 102.

Without wishing to be bound to any theory, it is believed that the ignition delay substance may act as an insulator that reduces the rate of heat transfer from the charcoal to the chimney 100. The ignition delay substance may reduce the thermal conductivity of the chimney 100 (on a surface(s) where the ignition delay substance is applied). Thus, the charcoal 10 is allowed to burn for a predetermined time (the first heating phase) before sufficient heat is transferred from the charcoal to the chimney 100 to initiate combustion of the chimney 100 (the second heating phase).

### Use

Although not shown in the drawings, the charcoal chimney 100 may be provided with an easy-to-carry handle. In one example, the handle may be secured to the top 103. In another example, the handle may be secured to one of the sidewalls 101. The charcoal chimney may be provided in an attractive package. An easy-to-carry handle may be attached to the packaging. The charcoal chimney may be provided with a pre-measured amount of charcoal contained therein for a single barbecue experience. This can prevent the user from having to open or handle messy charcoal. In one example, one or more layers of paper or paper pulp may be introduced between layers of pre-loaded charcoal briquettes in order to facilitate combustion of the briquettes. A ready-to-use charcoal chimney may simply be placed on a grill and lit by the user.

The charcoal chimney 100 may be provided with a wrapper printed with instructions, identifying material, and other graphics or text. This wrapper may be a paper wrapper, which can be lit and function much like a fuse or other combustible material to begin the first heating phase (compare to artificial lightable fire logs wrapped in paper).

In use, charcoal 10 (lump charcoal, charcoal briquettes, or any other type of charcoal) may be stacked in the chimney 100, as illustrated by FIG. 4. The charcoal may be added by the user. However an improved experience may be provided if the charcoal is provided pre-loaded in the charcoal chimney 100.

To use the charcoal chimney 100, the user may place the charcoal chimney 100 in a charcoal grill (e.g., a ceramic grill, a barrel grill, a kettle grill, etc.). The user may then light a combustible material, such as paper or other ignitable material, under the chimney. In another example, the user may light the fuse 302 of the chimney. In another example, the user may light a paper wrapper surrounding the chimney. The one or more holes 202 in the chimney body 102 allow sufficient airflow (from the bottom through the top of the chimney 100) such that the charcoal 10 ignites and begins heating/burning. This initial combustion stage may be referred to as a “first heating phase.” During this phase, the charcoal chimney 100 acts as a chimney.

After the charcoal in the chimney 100 has burned for a predetermined time and/or after the charcoal in the chimney 100 has reached/exceeded a threshold temperature (or a predetermined time after reaching a threshold temperature), the chimney 100 may ignite. This may be referred to as second heating phase. When the charcoal chimney ignites, it may provide additional heat and flame to combust the charcoal while the charcoal chimney simultaneously collapses or crumbles into the grill. This can cause the charcoal to spread or distribute within the grill (the subsequent combustion stage). The chimney 100 combusts and is converted to ashes in the bottom of the grill and is mixed with the burning charcoal. In some embodiments, when the chimney 100 combusts, the charcoal is fully heated. In some embodiments, the ignition delay substance may prevent the charcoal chimney 100 from igniting for up to about 30 minutes. In some embodiments, the charcoal is fully heated after 16-18 minutes after first igniting the charcoal. The time duration of the first heating phase may be varied depending upon the structure of the charcoal chimney 100, the thickness of the ignition delay substance coating, the amount of ignition delay substance incorporated into the chimney body, the amount of charcoal provided in the cavity 106, or any other factors. The examples provided are for illustration only and are not intended to be limiting in any way.

For example, different types and brands of charcoal have widely varying characteristics, such as average time to be fully heated. Accordingly, in addition to varying the size of the cavity 106 for the intended grill size/configuration (described above), the charcoal chimney 100 may be configured to provide a shorter or longer expected length of the first heating phase to meet the burn characteristics of a particular charcoal type. For example, the charcoal chimney 100 may be manufactured with multiple layers of ignition delay substance. The chimney 100 may be manufactured with any number of layers of ignition delay substance.

In some embodiments, the first heating phase may be between 1 and 30 minutes. After the charcoal 10 is first ignited, the charcoal may begin heating and, in certain embodiments, will burn for approximately 5 to 20 minutes before the chimney 100 ignites and begins combusting. In other embodiments, the charcoal may burn for approximately 10-12 minutes. If a charcoal chimney having a double coating of an ignition delay substance is used (e.g., having more than one layer of ignition delay substance applied onto a first cured layer), the first heating phase may be extended up to approximately 8 to 23 minutes or longer. In other embodiments, the first heating phase may be approximately 13-15 minutes. During the initial combustion stage/first heating phase, the charcoal chimney 100 acts as a chimney (does not burn) while the charcoal begins heating.

### Molded Charcoal and Charcoal Arrangement Devices

As shown in FIGS. 7-9B, in some embodiments, charcoal may be molded/pressed into shapes. One example of a molded shape is shown in FIG. 7 as an inverted nest cluster 401. Cluster 401 includes 12 individual briquettes attached to one another at their edges where each briquette has a triangular outline when viewed from above. When a pair of clusters are stacked on top of one another, the two clusters may be rotated about a vertical axial direction 402. FIG. 7 shows one example where 7 clusters are stacked to form a tower 407. Because the connection points between the briquettes may be thinner than the briquettes, the connection points may combust and weaken before the larger mass burns. The clusters can break at these points and the tower can collapse to produce a set of conventionally shaped coals ready for use. Spaced between the molded briquettes may provide for an increased airflow throughout the molded shape.

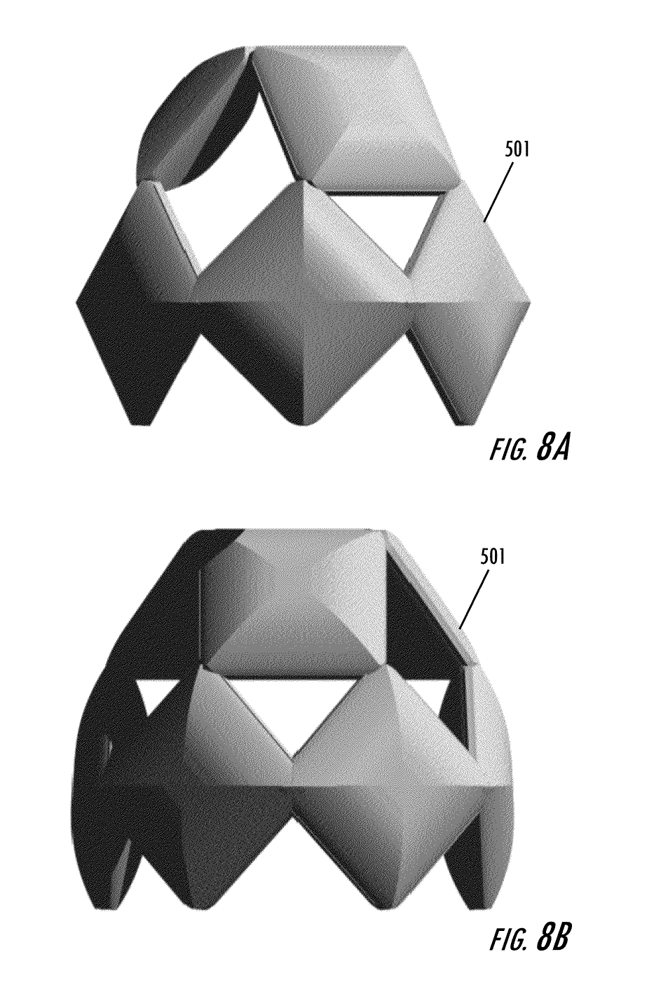

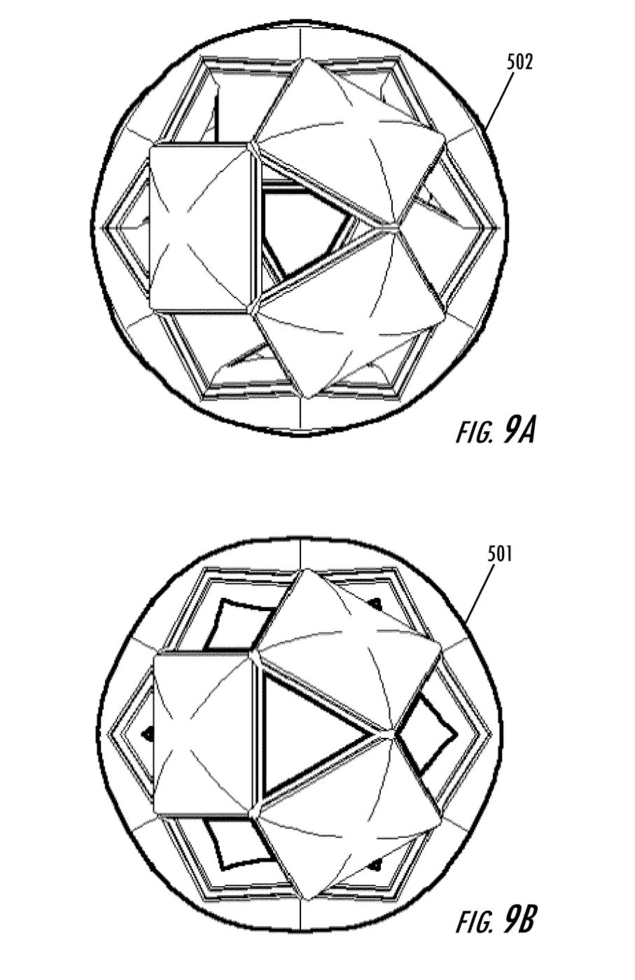

FIGS. 8A-9B show clusters 501 that include pillow-shaped charcoal briquettes attached to one another at their corners. FIGS. 8A and 8B show two different side views that are rotated relative to one another. FIG. 9B shows a top view of the cluster 501 and FIG. 9A shows a top view of a tower 502 of two clusters 501.

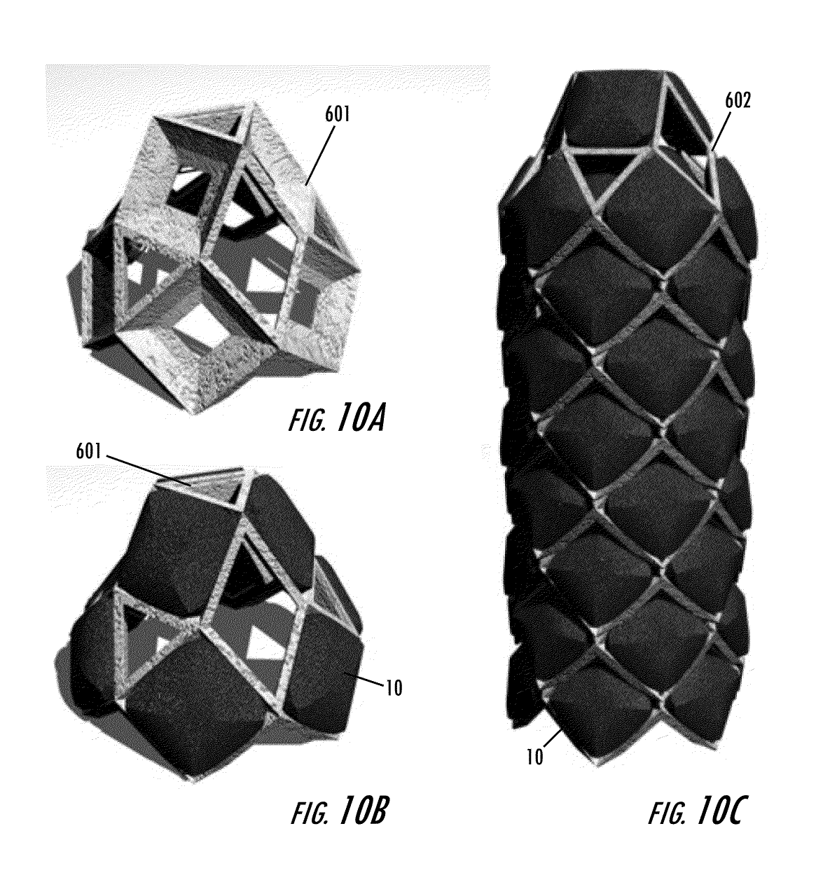

In some embodiments, as shown in FIGS. 10A-10C, commercially available charcoal briquettes 10 can be inserted into a charcoal arrangement device 601. The charcoal arrangement device 601 may be newspaper, paper pulp, cardboard, or any other type of paper product that is easily ignitable. FIG. 10C shows a tower 602 comprising a plurality of charcoal arrangement devices 601. The charcoal arrangement device 601 may be coated or impregnated or both with an ignition delay substance as described above.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

That which is claimed is:

1. A charcoal chimney comprising:
a chimney body comprising an interior cavity, at least one surface of the chimney body comprising a combustible material;
at least one hole in the chimney body; and
a non-toxic ignition delay substance associated with the at least one surface of the chimney body comprising a combustible material, wherein the non-toxic ignition delay substance delays ignition of the charcoal chimney upon application of heat during a first heating phase.

2. The charcoal chimney of claim 1, wherein the first heating phase comprises up to about 30 minutes, and wherein subsequent continued heating causes the charcoal chimney to combust.

3. The charcoal chimney of claim 1, wherein the non-toxic ignition delay substance comprises one or more of lime, casein protein, lime plaster, mud, plaster, mortar, cement, Portland cement, gypsum, gypsum plaster, plaster of Paris, or a combination thereof.

4. The charcoal chimney of claim 1, further comprising a removable top comprising an opening with a corresponding movable flap.

5. The charcoal chimney of claim 1, further comprising a plurality of feet extending below a bottom surface of the charcoal chimney.

6. The charcoal chimney of claim 1, further comprising a wick.

7. The charcoal chimney of claim 1, wherein the combustible material comprises one or more of paper, cardboard, papier-mâché, paper pulp, paper board, molded pulp, or any combination thereof.

8. The charcoal chimney of claim 1, wherein the non-toxic ignition delay substance comprises an at least partial coating on at least one surface of the chimney body.

9. The charcoal chimney of claim 8, wherein the at least partial coating comprises a coating on all surfaces of the chimney body, at least two coatings on one or more surfaces of the chimney body, or combinations thereof.

10. The charcoal chimney of claim 1, wherein the non-toxic ignition delay substance is formed into the combustible material such that it impregnates the chimney body.

11. The charcoal chimney of claim 1, wherein the non-toxic ignition delay substance comprises a combination of plaster of Paris, Portland cement, and water.

12. The charcoal chimney of claim 1, wherein the interior cavity is configured to support charcoal.

13. A method of using a charcoal chimney, the method comprising:
providing a charcoal chimney comprising a combustible material and a non-toxic ignition delay substance that delays ignition of the charcoal chimney upon application of heat during a first heating phase, wherein the charcoal chimney is configured to contain charcoal;
applying heat to charcoal disposed within the charcoal chimney, wherein the charcoal burns for the first heating phase without combusting the charcoal chimney, and wherein after the first heating phase, the charcoal chimney ignites from heat of the charcoal.

14. The method of claim 13, wherein the charcoal chimney is provided pre-loaded with charcoal.

15. The method of claim 13, wherein the charcoal chimney comprises an openable opening on the charcoal chimney, and further comprising opening the opening.

16. A method of manufacturing a charcoal chimney, the method comprising:
forming a chimney body comprising an interior cavity out of a combustible material;
applying one or more coats of a non-toxic ignition delay substance to at least one surface of the chimney body, wherein the non-toxic ignition delay substance delays ignition of the charcoal chimney upon application of heat during a first heating phase; and
allowing the non-toxic ignition delay substance to dry or cure.

17. The method of claim 16, further comprising:
pre-loading charcoal in the charcoal chimney; and
packaging the chimney body.

18. The method of claim 16, wherein the combustible material comprises one or more of paper, cardboard, papier-mâché, paper pulp, paper board, molded pulp, or combinations thereof.

19. The method of claim 16, wherein the coating comprises one or more of plaster of Paris, gypsum, Portland cement, and water.

20. The method of claim 19, wherein the coating comprises a ratio of between approximately 20:1 to 70:1 of plaster of Paris to Portland cement and a ratio of between approximately 1:1 to 3:1 of plaster of Paris to water.
